(19) United States
(12) Patent Application Publication
(10) Pub. No.: US 2017/0355642 A1
(43) Pub. Date: Dec. 14, 2017

(54) MONO- AND BISALKYLENETRIALKOXYSILANE DISPERSANTS FOR HYDRAULIC BINDERS

(71) Applicant: BASF SE, Ludwigshafen (DE)

(72) Inventors: Martin ERNST, Heidelberg (DE); Achim FESSENBECKER, Waghaeusel (DE)

(73) Assignee: BASF SE, Ludwigshafen (DE)

(21) Appl. No.: 15/520,888

(22) PCT Filed: Oct. 8, 2015
(86) PCT No.: PCT/EP2015/073270

§ 371 Date: Apr. 21, 2017

(30) Foreign Application Priority Data
Oct. 22, 2014 (EP) 14189932.8

(51) Int. Cl. C04B 24/42; C04B 28/02; C04B 28/00; C04B 14/02; C04B 103/40

(52) U.S. Cl. CPC C04B 24/42; C04B 28/006; C04B 14/02; C04B 28/02; C04B 2103/408

(57) ABSTRACT

The present invention relates to mono- and bisalkylenetrialkoxysilanes of the general formula (I),

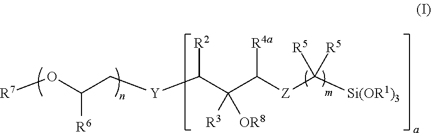

in which:
—Y— is —O— or —N(R⁹)₂₋ₐ—;
—Z— is in each case identical or different and selected from the group consisting of —O— and —CHR^{4b}—;
a is 1 if —Y—=—O—; and is 1 or 2 if —Y—=—N(R⁹)₂₋ₐ—;
m is a natural number from 1 to 20;
n is a natural number from 7 to 200;
R¹ is in each case identical or different and selected from the group consisting of methyl, ethyl, n-propyl, isopropyl, n-butyl, isobutyl, sec-butyl, tert-butyl, and phenyl; and
R², R³, R^{4a}, R^{4b}, R⁵, R⁶, R⁷R⁸, and R⁹ in each case independently are H, suitable linear or branched C₁-C₂₀-alkyl, or optionally C₂-C₂₀-alkenyl, C₂-C₂₀-alkynyl, C₁-C₂₀-alkanoyl, C₃-C₂₀-alkenoyl, ω-carboxy-(C₁-C₆-alkyl)carbonyl, and ω-carboxy-(C₂-C₆-alkenyl)carbonyl and/or C₇-C₂₀-aryloyl;
   to processes for preparing them and to their use as dispersants in aqueous suspensions composed of aggregates and hydraulic binders; and to these aqueous suspensions as such.

The present invention relates to mono- and bisalkylenetrialkoxysilanes as such and to a process for preparing them, and also to the use thereof as dispersants in aqueous suspensions composed of aggregates and hydraulic binders. The invention also relates to the aqueous suspensions as such.

Aqueous suspensions comprising an aggregate and a hydraulic binder frequently have their chemical and/or physical properties influenced by addition of auxiliaries in the form of dispersants. A particular purpose this serves is to prevent the formation of agglomerates of solids, and also to disperse the particles already present and those newly formed by hydration, in order thereby to suppress the sedimentation propensity and to improve the workability, such as kneadability, spreadability, sprayability, pumpability, or flowability. This effect is also exploited in a targeted way in the production of building material mixtures which comprise hydraulic binders such as cement, render binders and masonry binders, or hydraulic lime.

In order to convert these building material mixtures comprising hydraulic binders into a ready-to-use, workable form, the quantity of mixing water required is usually substantially more than would be necessary for the subsequent process of hydration or hardening. But a possible result of the excess water, which later evaporates, is the formation of void fractions within the concrete structure, which significantly impair its mechanical strength and durability.

Because of this, in order to reduce the excess water fraction for a specified working consistency and/or to improve the workability for a specified ratio of water to hydraulic binder, special auxiliaries are often used, which are generally referred to as diluents, water reducers, or plasticizers. Plasticizers conventionally used are, for example, sulfonated melamine-formaldehyde condensates (SMF), sulfonated naphthalene-formaldehyde condensates (SNF), or lignosulfonates.

Polycarboxylate esters and polycarboxylate ethers are considered to be new-generation plasticizers/water reducers. They consist in general of a main chain, based on poly(meth)acrylate, and of a plurality of sidechains, attached via ester groups, and are frequently referred to as comb polymers. While the main chain is negatively charged at alkaline pH levels, owing to the numerous carboxylate groups, the sidechains, such as polyethylene glycol sidechains, for example, commonly possess no charge. Because of the negatively charged main chain, the polycarboxylate esters and/or ethers are adsorbed on charged particle surfaces, where they form a more or less dense polymer layer. The amount of adsorbed polymer and the nature of the polymer sidechain determine the density and thickness of the polymer layer, which in turn influences the flowability of the suspension. While the anionic charge of the polycarboxylate esters or ethers allows them to be adsorbed onto the particles, the dispersing activity is influenced critically by the steric interactions caused by the polyethylene glycol sidechains. Both sidechain length and chain density affect the dispersing activity.

EP 0 803 521 A1 discloses, for example, block copolymers comprising polyalkylene glycol and polyglyoxylate structural units, and the use thereof as cement dispersants.

In addition there are a range of other plasticizers/water reducers, which differ from the polycarboxylate polymers described in that they do not possess any carboxylate groups. Instead, they have other acid groups, such as phosphonic acid groups, which are nevertheless likewise negatively charged at high pH levels, similarly to the carboxylate groups.

U.S. Pat. No. 5,879,445 A discloses compounds which comprise at least one phosphonic aminoalkylene group and at least one polyoxyalkylated chain, and also the use thereof as plasticizers for aqueous suspensions comprising mineral particles and hydraulic binders.

EP 444 542 discloses polyethyleneimine phosphonate derivatives as plasticizers/water reducers allowing the viscosity of well cement compositions to be reduced to an extent that they are pumpable under the conditions of turbulent flow even in the presence of salts.

EP 1203046 B1 describes plasticizers/water reducers with alkylenetrialkoxysilane groups, of the general formula

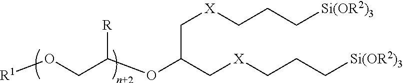

where
R is selected independently from H, methyl, ethyl, propyl, and styrene;
R¹ is selected from H, C₁-C₁₈-alkyl, phenyl, benzyl, and alkylsulfonate;
R² is selected from H and C₁-C₆-alkyl;
n is a number from 10 to 500; and
X is selected from

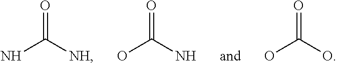

A disadvantage is the costly and inconvenient preparation of such dispersants, involving isocyanate reagents. Other possibilities for preparation are not disclosed.

Although good results are already being achieved in some cases with the dispersants described, there is nevertheless a wide remaining space for improvements.

The dispersants described do in part have a very good diluent effect, allowing the water demand to be reduced in relation to the hydraulic binder, for specified consistency. In many cases, however, this diluent effect is not associated to the desired level with a reduction in viscosity, and this perceptibly detracts from the workability, such as the pumpability, for example.

Other dispersants may indeed lower the viscosity of building material mixtures comprising hydraulic binders, permitting an improvement in the flow property and hence also in the workability. Frequently, however, they have a less pronounced diluent effect and/or carry unwanted side-effects, such as a perceptible retardation of setting, segregation of the mixture, and exudation of the mixing water, for example. They are therefore of only limited usefulness, especially when the desire is for a short setting time on the part of the hydraulic binder. In order to achieve the desired improvement in workability, especially in pumpability, these existing dispersants would have to be employed in quantities at which such side-effects would occur to an increased extent.

The problem addressed by the present invention is that of providing a dispersant which is especially suitable as a plasticizer/water reducer in aqueous suspensions comprising aggregates and hydraulic binders, without severely retarding the setting time of the hydraulic binder.

It has been found that the use of mono- and bisalkylenetrialkoxysilanes of the general formula (I) as dispersants for aqueous suspensions comprising aggregates and hydraulic binders is able to lessen the water demand and ensures good workability of the aqueous suspension, without at the same time severely retarding the setting time of the hydraulic binder.

The invention accordingly provides mono- and bisalkylenetrialkoxysilanes of the general formula (I),

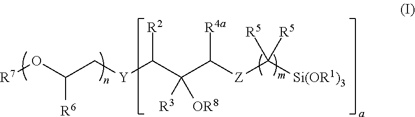

in which:
—Y— is —O— or —N(R⁹)₂₋ₐ—;
—Z— is in each case identical or different and selected from the group consisting of —O— and —CHR^{4b}—;
a is 1 if —Y—=—O—; and is 1 or 2 if —Y—=—N(R⁹)₂₋ₐ—;
m is a natural number from 1 to 20;
n is a natural number from 7 to 200;
R¹ is in each case identical or different and selected from the group consisting of methyl, ethyl, n-propyl, isopropyl, n-butyl, isobutyl, sec-butyl, tert-butyl, and phenyl;
R², R³, R^{4a} and R^{4b} are in each case identical or different and selected from the group consisting of H and linear or branched C₁-C₁₀-alkyl; or
   R² together with R^{4a} forms an alkylene chain —R²—R^{4a}—, the alkylene chain being selected from the group consisting of —C(R⁵)₂—C(R⁵)₂— and —C(R⁵)₂—C(R⁵)₂—C(R⁵)₂—, and R³ and R^{4b} are in each case identical or different and selected from the group consisting of H and linear or branched C₁-C₁₀-alkyl; or
   R² together with R^{4b} forms an alkylene chain —R²—R^{4b}—, the alkylene chain being selected from the group consisting of —C(R⁵)₂— and —C(R⁵)₂—C(R⁵)₂—, and R³ and R^{4a} are in each case identical or different and selected from the group consisting of H and linear or branched C₁-C₁₀-alkyl;
R⁵ is in each case identical or different and selected from the group consisting of H and linear or branched C₁-C₆-alkyl;
R⁶ is in each case identical or different and selected from the group consisting of H, methyl, and ethyl;
R⁷ is selected from the group consisting of linear or branched C₁-C₂₀-alkyl, C₁-C₂₀-alkanoyl, and C₇-C₂₀-aryloyl;
R⁸ and R⁹ are in each case identical or different and selected from the group consisting of H, linear or branched C₁-C₂₀-alkyl, C₂-C₂₀-alkenyl, C₂-C₂₀-alkynyl, C₁-C₂₀-alkanoyl, C₃-C₂₀-alkenoyl, and also ω-carboxy-(C₁-C₆-alkyl)carbonyl and salts thereof, ω-carboxy-(C₂-C₆-alkenyl)carbonyl and salts thereof, and also C₇-C₂₀-aryloyl.

The mono- and/or bisalkylenetrialkoxysilanes of the general formula (I) do not necessarily have anionic groups, as do the dispersants known from the prior art. They are presumably able, under the basic conditions prevailing in the aqueous suspension, to be bonded covalently to silicate phases of particulate solids in the hydraulic binder. It is presumed that the trialkoxysilane group here serves as an anchor, to fix the polyoxyalkylene chain on the particle surface.

By virtue of the fact that the mono- and bisalkylenetrialkoxysilanes of the general formula (I) can be charge-neutral, and this neutrality is likely also retained after a presumed basic hydrolysis and formation of covalent bonds to the silicate phases of particles that are to be dispersed, the effect on the setting time of the hydraulic binder is much less than is the case with the usually multiply negatively charged plasticizers from the prior art.

The term “plasticizer” refers for the purposes of the present invention to an admixture which leads to an improvement in the workability and also, optionally, to a reduction in the water demand in the production of aqueous suspensions comprising hydraulic binders.

In the context of the present invention, the expression “C₁-C₆-alkyl” encompasses not only the acyclic hydrocarbon groups methyl, ethyl, n-propyl, isopropyl, n-butyl, sec-butyl, isobutyl, tert-butyl, n-pentyl, 1-methylbutyl, 2-methylbutyl, 3-methylbutyl, 1,1-dimethylpropyl, 2,2-dimethylpropyl, 1,2-dimethylpropyl, 1-ethylpropyl, n-hexyl, 1-methylpentyl, 2-methylpentyl, 3-methylpentyl, 4-methylpentyl, 1,1,-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1-ethyl-1-methyl-propyl, 1-ethyl-2-methylpropyl, 2-ethyl-1-methylpropyl, and 2-ethyl-2-methylpropyl but also the cyclic hydrocarbon groups cyclopropyl, cyclobutyl, cyclopentyl, 1-methylcyclobutyl, 2-methylcyclobutyl, 3-methylcyclobutyl, cyclohexyl, 1-methylcyclopentyl, 2-methylcyclopentyl, 3-methylcyclopentyl, 1,2-dimethylcyclobutyl, 1,3-dimethylcyclobutyl, 2,2-dimethylcyclobutyl, 2,3-dimethylcyclobutyl, and 3,3-dimethylcyclobutyl.

Correspondingly, the expression “C₁-C₁₀-alkyl” encompasses all saturated, cyclic, or acyclic hydrocarbon groups having 1 to 10 carbon atoms. Encompassed in addition to the hydrocarbon groups listed above for “C₁-C₆-alkyl”, accordingly, are also, in particular, n-heptyl, 5-methylhexyl 2-ethyl-3-methylbutyl, n-octyl, 5-methylheptyl 4,4-dimethylhexyl, 3-ethylhexyl, 2-ethyl-3-methylpentyl, n-nonyl, n-decyl, cyclodecyl, and decalinyl.

Similar comments apply to the expression “C₁-C₂₀-alkyl”, which in addition to the hydrocarbon groups stated in connection with the expression “C₁-C₁₀-alkyl”, also encompasses, in particular, n-undecyl, n-dodecyl, n-tridecyl, n-tetradecyl, n-pentadecyl, n-hexadecyl, n-heptadecyl, n-octadecyl, n-nonadecyl, and n-eicosanyl.

The expression “C₂-C₂₀-alkenyl” in the context of the present invention is used for cyclic or acyclic hydrocarbon groups having 2 to 20 carbon atoms and comprising one or more olefin groups. The expression “C₂-C₂₀-alkenyl” encompasses not only the acyclic hydrocarbon groups having 2 to 6 carbon atoms (acyclic “C₂-C₆-alkenyl”) vinyl, prop-1-enyl, prop-2-enyl (allyl), methallyl, 1-methylallyl, homoallyl, but-2-enyl, pent-1-enyl, pent-2-enyl, pent-3-enyl, 1-methylbut-1-enyl, 2-methylbut-1-enyl, 3-methylbut-1-enyl, 1-methylbut-2-enyl, 2-methylbut-2-enyl, 3-methylbut-2-enyl, 1-methylbut-3-enyl, 2-methylbut-3-enyl, 3-methylbut-3-enyl, 1-ethylprop-1-enyl, 1-ethylprop-2-enyl, hex-1-enyl, hex-2-enyl, hex-3-enyl, hex-4-enyl, hex-5-enyl, 1-methylpent-1-enyl, 2-methylpent-1-enyl, 3-methylpent-1-enyl, 4-methylpent-1-enyl, 1-methyl pent-2-enyl, 2-methylpent-2-enyl, 3-methylpent-2-enyl, 4-methylpent-2-enyl, 1-methyl pent-3-enyl, 2-methylpent-3-enyl, 3-methylpent-3-enyl, 4-methylpent-3-enyl, 1-methyl pent-4-enyl, 2-methylpent-4-enyl, 3-methylpent-4-enyl, 4-methylpent-4-enyl, 1,2-dimethylbut-1-enyl, 1,3-dimethylbut-1-enyl, 3,3-dimethylbut-1-enyl, 1,1-dimethylbut-2-enyl, 1,2-dimethylbut-2-enyl, 1,3-dimethylbut-2-enyl, 2,3-dimethylbut-2-enyl, 1,1-dimethylbut-3-enyl, 1,2-dimethylbut-3-enyl, 1,3-dimethylbut-3-enyl, 2,2-dimethylbut-3-enyl, and 2,3-dimethylbut-3-enyl, but also, in particular, the acyclic hydrocarbon groups having 7 to 20 carbon atoms: heptenyl, octenyl, nonenyl, decenyl, undecenyl, dodecenyl, tridecenyl, tetradecenyl, pentadecenyl, hexadecenyl, heptadecenyl, octadecenyl, nonadecenyl, and eicosenyl, and also the cyclic hydrocarbon groups cyclobut-1-enyl, cyclobut-2-enyl, cyclopent-1-enyl, cyclopent-2-enyl, cyclopent-3-enyl, cyclohex-1-enyl, cyclohex-2-enyl, cyclohex-3-enyl, and cyclodecenyl.

In the context of the present invention, the expression “C₂-C₂₀-alkynyl” is used for hydrocarbon groups having 2 to 20 carbon atoms and comprising one or more carbon-carbon triple bonds. The expression “C₂-C₂₀-alkynyl” encompasses, in particular, ethynyl, prop-2-ynyl, but-2-ynyl, but-3-ynyl, 1-methylprop-2-ynyl, pent-2-ynyl, pent-3-ynyl, pent-4-ynyl, 1-methylbut-2-ynyl, 1-methylbut-3-ynyl, 2-methylbut-3-ynyl, hex-2-ynyl, hex-3-ynyl, hex-4-ynyl, hex-5-ynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, and eicosynyl.

In the context of the present invention, the expression “C₁-C₂₀-alkanoyl” encompasses all cyclic or acyclic alkylcarbonyl groups having 1 to 20 carbon atoms. More particularly the expression “C₁-C₂₀-alkanoyl” encompasses formyl, ethanoyl (acetyl), propanoyl, butanoyl, 2-methyl-propanoyl, pentanoyl, 2-methylbutanoyl, 3-methylbutanoyl, 2,2-dimethylpropanoyl, cyclopentanoyl, hexanoyl, 2-methylpentanoyl, 3-methylpentanoyl, 4-methylpentanoyl, 2,2-dimethylbutanoyl, 2,3-dimethylbutanoyl, 3,3-dimethylbutanoyl, cyclohexanoyl, heptanoyl, 2-methylhexanoyl, 3-methylhexanoyl, 4-methylhexanoyl, 5-methylhexanoyl, 4,4-dimethylpentanoyl, octanoyl, nonanoyl, decanoyl, cyclodecanoyl, dodecanoyl, tridecanoyl, tetradecanoyl, pentadecanoyl, hexadecanoyl, heptadecanoyl, octadecanoyl, nonadecanoyl, and eicosanoyl.

The expression “C₃-C₂₀-alkenoyl” in the context of the present invention is used for all alkenylcarbonyl groups having 3 to 20 carbon atoms and comprising one or more olefin groups. The expression “C₃-C₂₀-alkenoyl” encompasses, in particular, acryloyl, methacryloyl, but-2-enoyl, but-3-enoyl, cyclobutenylcarbonyl, pent-2-enoyl, pent-3-enoyl, pent-4-enoyl, cyclopentenylcarbonyl, hex-2-enoyl, hex-3-enoyl, hex-4-enoyl, hex-5-enoyl, cyclohexenylcarbonyl, heptenoyl, octenoyl, nonenoyl, decenoyl, cyclodecenoyl, undecenoyl, dodecenoyl, tridecenoyl, tetradecenoyl, pentadecenoyl, hexadecenoyl, heptadecenoyl, octadecenoyl, nonadecenoyl, and eicosenoyl.

In the context of the present invention, the expression “ω-carboxy-(C₁-C₆-alkyl)carbonyl” encompasses all acyclic alkylcarbonyl groups having a total of 3 to 8 carbon atoms and substituted terminally by a carboxy functionality (COOH). The expression “C₁-C₆-alkyl” within parentheses here has the definition already given above. Examples of such ω-carboxy-(C₁-C₆-alkyl)carbonyls are 2-carboxyethanoyl (1-carboxymethylcarbonyl), 3-carboxypropanoyl (2-carboxyethylcarbonyl), 4-carboxybutanoyl (3-carboxypropylcarbonyl), and 3-carboxy-2-methylpropanoyl (corresponding to 2-carboxy-1-methylethylcarbonyl). “Salts of ω-carboxy-(C₁-C₆-alkyl)carbonyl” in the context of the present invention are “ω-carboxy-(C₁-C₆-alkyl)carbonyls”, in which the hydrogen of the carboxy functionality (COOH) is replaced by a metal, more particularly an alkali metal or alkaline earth metal (preferably Li, Na, K, [Mg]_{0.5} or [Ca]_{0.5}).

In the context of the present invention, the expression “ω-carboxy-(C₂-C₆-alkenyl)carbonyl” encompasses all acyclic alkenylcarbonyl groups having a total of 3 to 8 carbon atoms and substituted terminally by a carboxy functionality (COOH). The expression “C₂-C₆-alkenyl” within parentheses here has the definition already given above. Examples of such ω-carboxy-(C₂-C₆-alkenyl)carbonyls are 2-carboxyethenylcarbonyl and 3-carboxyprop-1-enylcarbonyl. “Salts of ω-carboxy-(C₂-C₆-alkenyl)carbonyl” in the context of the present invention are “ω-carboxy-(C₂-C₆-alkenyl)carbonyls” in which the hydrogen of the carboxy functionality (COOH) is replaced by a metal, more particularly an alkali metal or alkaline earth metal (preferably Li, Na, K, [Mg]_{0.5} or [Ca]_{0.5}).

The expression “C₇-C₂₀-aryloyl” in the context of the present invention encompasses phenylcarbonyl and also all hydrocarbon groups containing a phenylcarbonyl substructure and having 7 to 20 carbon atoms. More particularly the expression “C₇-C₂₀-aryloyl” encompasses phenylcarbonyl, 2-methylphenylcarbonyl, 3-methylphenylcarbonyl, 4-methylphenylcarbonyl, 2,3-dimethylphenylcarbonyl, 2,4-dimethylphenylcarbonyl, 2,5-dimethylphenylcarbonyl, 2,4,6-trimethylphenylcarbonyl, 1-naphthylcarbonyl, 2-naphthylcarbonyl, 9-anthrylcarbonyl, and 9-phenanthrylcarbonyl.

Preferably m in the mono- and bisalkylenetrialkoxysilanes of the general formula (I) is a natural number from 1 to 10, more preferably a natural number from 1 to 5, and very preferably 1 to 3.

In the mono- and bisalkylenetrialkoxysilanes of the general formula (I), n is preferably a natural number from 11 to 150, more preferably a natural number from 16 to 125, and very preferably a natural number from 21 to 125.

In the mono- and bisalkylenetrialkoxysilanes of the general formula (I), R¹ is preferably selected independently from methyl, ethyl, tert-butyl, and phenyl. More preferably R¹ is selected independently from methyl and ethyl.

R⁵ is preferably H.

R⁶ is selected independently at each occurrence from the group consisting of H, methyl, and ethyl. H, methyl, and ethyl here may for example be arranged with statistical distribution on the polyethylene oxide chain consisting of n alkylene oxide units, or in the form of one or more blocks each with identical R⁶. In the context of the present invention, a “block in each case with identical R⁶” means a portion of the polyethylene oxide chain that consists of at least 2 directly adjacent alkylene oxide units, in which the alkylene oxide units have identical R⁶s. The polyethylene oxide chain consisting of n alkylene oxide units preferably has a plurality of blocks each with identical R⁶. With particular preference R⁶ is selected independently from H and methyl. Very preferably R⁶=H.

R⁷ in the mono- and bisalkylenetrialkoxysilanes of the general formula (I) is preferably selected from the group consisting of H, methyl, and acetyl (C(═O)Me). Particularly preferred are H and methyl. Very preferably R⁷=methyl.

R⁸ in the mono- and bisalkylenetrialkoxysilanes of the general formula (I) is preferably selected from the group consisting of H, C₁-C₂₀-alkanoyl, C₇-C₂₀-aryloyl, carboxy-(C₁-C₆-alkyl)carbonyl, and carboxy-(C₂-C₆-alkenyl)carbonyl.

In one specific embodiment of the present invention, R⁸ is H. Mono- and bisalkylenetrialkoxysilanes of this specific embodiment are covered by the formula (I-a),

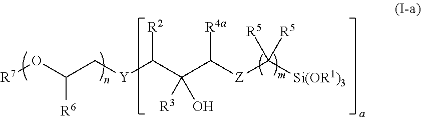

in which Y, Z, a, m, n, R¹ to R⁷, and R⁹ have the definition indicated above for mono- and bisalkylenetrialkoxysilanes of the general formula (I).

In another specific embodiment, the mono- and bisalkylenetrialkoxysilanes have the formula (I-b),

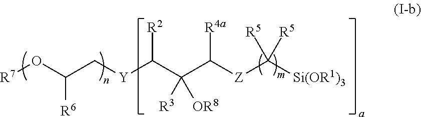

in which Y, Z, a, m, n, R¹ to R⁷, and R⁹ have the definition indicated above for mono- and bisalkylenetrialkoxysilanes of the general formula (I), and R⁸ is selected from the group consisting of carboxy-(C₁-C₆-alkyl)carbonyl and carboxy-(C₂-C₆-alkenyl)carbonyl.

In one embodiment of the present invention, —Y— in the mono- and bisalkylenetrialkoxysilanes of general formula (I) is —N(R⁹)₂₋ₐ—, and a=2.

In another embodiment of the present invention, —Y— in the general formula (I) is —N(R⁹)₂₋ₐ—, and a=1.

R⁹ in this embodiment is preferably selected from the group consisting of linear or branched C₁-C₂₀-alkanoyl, C₇-C₂₀-aryloyl, carboxy-(C₁-C₆-alkyl)carbonyl, and carboxy-(C₂-C₆-alkenyl)carbonyl.

In one particularly preferred embodiment of the present invention, R⁹=R⁸ and is selected from the group consisting of C₁-C₂₀-alkanoyl, C₇-C₂₀-aryloyl, carboxy-(C₁-C₆-alkyl)carbonyl, and carboxy-(C₂-C₆-alkenyl)carbonyl.

In another embodiment of the present invention, —Y— in the general formula (I) is —O—, and a is 1.

In a preferred embodiment of the present invention, a feature of the mono- and bisalkylenetrialkoxysilanes of the general formula (I) is that —Z— is —O—. In the preferred embodiment of the present invention, R², R³, and R^{4a} in the general formula (I) are preferably in each case identical or different and selected from the group consisting of H and linear or branched C₁-C₁₀-alkyl. Mono- and bisalkylenetrialkoxysilanes of this preferred embodiment are covered by the formula (I-c),

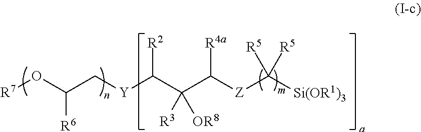

in which Y, a, m, n, R¹, and R⁵ to R⁹ have the definition indicated above for mono- and bisalkylenetrialkoxysilanes of the general formula (I), and R², R³, and R^{4a} are in each case identical or different and selected from the group consisting of H and linear or branched C₁-C₁₀-alkyl.

In one especially preferred embodiment of the present invention, in the general formula (I), —Z— is —O—, —Y— is —N(R⁹)₂₋ₐ—, and a=2.

In another very preferred embodiment, in the general formula (I), —Z— is —O—, —Y— is-N(R⁹)₂₋ₐ—, a=1, and R⁹=R⁸, and R⁸ and R⁹ are selected from the group consisting of C₁-C₂₀-alkanoyl, C₇-C₂₀-aryloyl, carboxy-(C₁-C₆-alkyl)carbonyl, and carboxy-(C₂-C₆-alkenyl)carbonyl.

In another preferred embodiment of the present invention, in the mono- and bisalkylenetrialkoxysilanes of the general formula (I), —Z— is —CHR^{4b}—; and R² together with R^{4a} forms an alkylene chain —R²—R^{4a}—, this alkylene chain being selected from the group consisting of —C(R⁵)₂—C(R⁵)₂— and —C(R⁵)₂—C(R⁵)₂—C(R⁵)₂—, and R³ and R^{4b} are in each case identical or different and selected from the group consisting of H and linear or branched C₁-C₁₀-alkyl; or R² together with R^{4b} forms an alkylene chain —R²—R^{4b}—, this alkylene chain being selected from the group consisting of —C(R⁵)₂— and —C(R⁵)₂—C(R⁵)₂—, and R³ and R^{4a} are in each case identical or different and selected from the group consisting of H and linear or branched C₁-C₁₀-alkyl.

Particularly preferred mono- and bisalkylenetrialkoxysilanes of this embodiment have the formula (I-d1), (I-d2), (I-d3), or (I-d4),

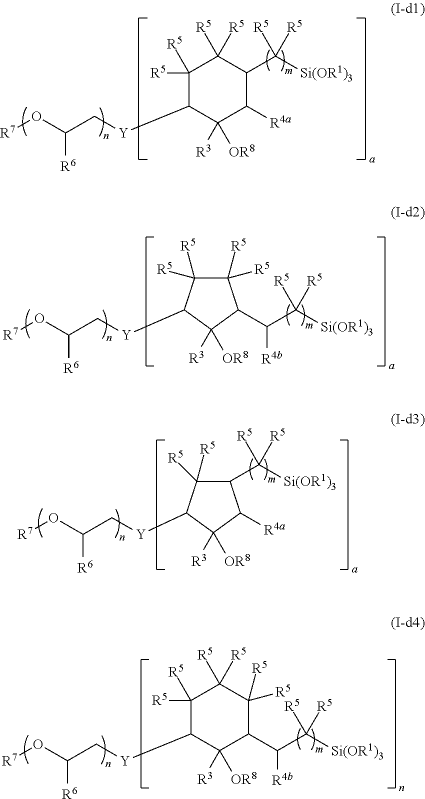

in which Y, a, m, n, R¹, and R⁵ to R⁹ have the definition indicated above for mono- and bisalkylenetrialkoxysilanes of the general formula (I), and R³, R^{4a}, and R^{4b} are in each case identical or different and selected from the group consisting of H and linear or branched C₁-C₁₀-alkyl.

Very preferably the mono- and bisalkylenetrialkoxysilanes are of the formula (I-d1). In one variant of this very preferred embodiment, m=2, and R³=R^{4a}=R⁵=H.

The present invention also, accordingly, provides mono- and bisalkylenetrialkoxysilanes of the formula (I-d11),

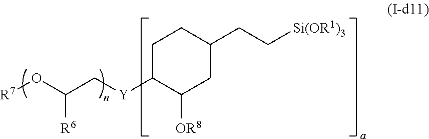

in which Y, a, n, R¹, and R⁶ to R⁹ have the definition indicated above for mono- and bisalkylenetrialkoxysilanes of the general formula (I).

The mono- and/or bisalkylenetrialkoxysilanes of the general formula (I) can be added dilute or neat at different stages in the preparation of aqueous suspensions, specifically during the actual preparation of the binders, or not until the stage of the mixing of the binders with water. They may therefore be added, for example, during the milling of cement, before, together with, or after the addition of milling assistants, early-strength enhancers, other plasticizers and water reducers, or on their own. They may likewise be sprayed onto components of, or finished, dry mortar mixtures. They then develop their effect at the time the pulverulent mixtures or granules are contacted with water for application in the form of aqueous suspensions.

The mono- and/or bisalkylenetrialkoxysilanes of the general formula (I) are generally water-soluble or water-dispersible. They may be liquid or solid; they frequently possess a waxy consistency. It is advantageous to provide the mono- and/or bisalkylenetrialkoxysilanes of the general formula (I) in the form of an aqueous solution, in order to facilitate metering in the possible applications. This aqueous solution may comprise further additives such as air entrainers, defoamers, emulsifiers, and the like. Mono- and/or bisalkylenetrialkoxysilanes of the general formula (I) may also be provided as a powder, or else as a powder which comprises a carrier such as silica or CaCO₃, for example, or in the form of flakes. The mono- and/or bisalkylenetrialkoxysilanes of the general formula (I) are provided preferably in the form of an aqueous solution or as a powder.

The present specification also provides the use of mono- and/or bisalkyltrialkoxysilanes of the general formula (I) as dispersants in aqueous suspensions comprising an aggregate and a hydraulic binder.

The aqueous suspension is generally a building material mixture, preferably concrete or mortar.

When mono- and/or bisalkylenetrialkoxysilanes of the general formula (I) are used as dispersants for aqueous suspensions comprising an aggregate and a hydraulic binder, the alkylenetrialkoxysilane presumably bonds covalently to silicate phases of particles of the hydraulic binder. Accordingly, alkylenetrialkoxysilane ought, for example, to bind to tricalcium silicate (alite) and/or dicalcium silicate (belite) phases of the clinker particles in the cement. Of course, however, it ought also to bind to silicate phases which are present in the selected aggregate. Mono- and/or bisalkylenetrialkoxysilanes of the general formula (I) are therefore particularly suitable for hydraulic binders having an SiO₂ content of at least 2 wt %, based on the dry mass of the hydraulic binder. Hydraulic binders are binders which, after having been mixed with water, harden both in air and under water, and which, after having hardened, remain solid and dimensionally stable even under water.

The amount of mono- and/or bisalkylenetrialkoxysilane of the general formula (I) used is dependent on the requirements imposed on the aqueous suspension. Generally speaking, the mono- and/or bisalkylenetrialkoxysilanes are used in an amount of 0.005 to 5.0 wt %, based on the dry weight of the hydraulic binder, in the aqueous suspension. The mono- and/or bisalkylenetrialkoxysilanes of the general formula (I) are used preferably in an amount of 0.01 to 2.0 wt %, more preferably in an amount of 0.01 to 1.0 wt %, based on the dry weight of the hydraulic binder.

The mono- and/or bisalkylenetrialkoxysilanes of the general formula (I) may be added before addition of the other components, simultaneously with one or more other components, or after the addition of the other components. The entire amount of mono- and/or bisalkylenetrialkoxysilanes here may be added all at once or in portions.

Preferred hydraulic binders are selected from cement, hydraulic lime, and geopolymeric silicate binder. With particular preference the hydraulic binder is selected from cement and geopolymeric silicate binder. With very particular preference the hydraulic binder is selected from Portland cement, Portland slag cement, Portland silicate cement, Portland pozzolan cement, Portland flyash cement, Portland shale cement, Portland limestone cement, Portland composite cement, blast furnace cement, pozzolanic cement, composite cement, and mixtures thereof.

The term “aggregate” in the context of the present invention refers to all kinds of aggregates which may be included in hydraulic binders and which have a suitable dimensional stability. The aggregates may come from natural deposits or may be obtained in the recycling of building materials or as industrial byproducts. Examples of suitable aggregates include uncrushed gravels and sand, gravelly material, chippings, crushed sands, rocks, blast furnace slag, fragmented clinker, recycled concrete chippings, pumice, larva sand, larva gravel, kieselguhr, expanded slate, expanded clay, pumice slag, heavy spar (barytes), magnetite, hematite, limonite, and scrap.

Examples of suitable water for addition to the aqueous suspension include drinking water, ground water, and natural surface water (e.g., river water, lake water, spring water).

The present invention also provides an aqueous suspension which comprises as dispersants the mono- and/or bisalkylenetrialkoxysilanes of the general formula (I) and comprises an aggregate and also a hydraulic binder.

The precise amount of hydraulic binder used in the aqueous suspension, and the ratio of water to hydraulic binder, are critically dependent on the requirements imposed on the aqueous suspension and on the fully cured solid that is formed from it. The same applies with respect to the nature of the aggregate to be used, the particle size group to be employed, and the relative quantity, especially the relative quantity with respect to the hydraulic binder. Moreover, the matter of whether and, if so, which auxiliaries, ancillary substances and/or fibers are added is critically dependent on the specific requirements. The nature and amount of these components to be used for a specific application are laid down exactly in numerous DIN EN standards, for example. For concrete and its individual components, for example, data are found in the following standards: DIN EN 206-1, DIN EN 197, DIN EN 12620, DIN EN 13139, DIN EN 13055-1, DIN EN 934-2, DIN EN 14889, DIN EN 1008. For mortar, the standard DIN EN 998-2, in particular, contains data on the nature and amount of the components to be used in each case for specific applications.

Generally speaking, the amount of hydraulic binder is between 100 and 600 kg/m³, the amount of aggregate is between 1000 and 3000 kg/m³, and the water content is between 50 and 600 kg/m³, based on one m³ of aqueous suspension. The ratio of water to hydraulic binder is typically 0.3 to 0.6.

The amount of mono- and/or bisalkylenetrialkoxysilane of the general formula (I) in the aqueous suspension is fundamentally 0.005 to 5.0 wt %, preferably 0.01 to 2.0 wt %, and more preferably 0.01 to 1.0 wt %, based on the dry weight of the hydraulic binder employed.

Optionally there may be admixtures present in the aqueous suspension. “Admixtures” in the sense of the present invention are liquid, pulverulent, or granulated substances which may be added to the suspension in small quantities, based on the dry mass of the hydraulic binder.

They influence the properties of the suspension by chemical and/or physical effects. Suitable admixtures include setting accelerators, setting retarders, air entrainers, sealants, foam formers, defoamers, solidification accelerators, hardening accelerators, corrosion inhibitors, sedimentation reducers, other plasticizers and water reducers, e.g., polycarboxylate ethers, beta-naphthylsulfonic acid-formaldehyde condensates (BNS), lignosulfonate, sulfonated melamine-formaldehyde condensate, and mixtures thereof.

An optional possibility, furthermore, is for additives and fibers to be present in the aqueous suspension. “Additives” in the sense of the present invention are fine organic or inorganic substances which are used in order to improve properties in a targeted way. They include virtually inert additives such as finely ground minerals, pigments, and also pozzolanic or latent hydraulic additives such as trass, flyash, silica dust, and finely ground slag sand. “Fibers” in the sense of the present invention are steel fibers, polymer fibers, and glass fibers in various sizes.

The present invention also provides a process for preparing mono- and/or bisalkylenetrialkoxysilanes of the general formula (I), comprising the following steps:
(i) β-hydroxyalkylating a polyether alcohol or polyether amine of the general formula (II),

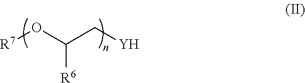

in which Y, n, R⁶, and R⁷ have the definition indicated above,
with one or more epoxy silanes of the general formula (III),

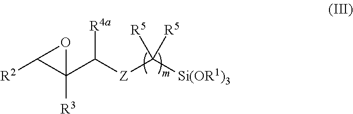

in which Z, m, R¹, R², R³, R^{4a}, and R⁵ have the definition indicated above,
to form specific mono- and/or bisalkylenetrialkoxysilanes of the general formula (I-a),

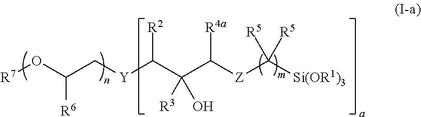

in which Y, Z, m, n, R¹, R², R³, R^{4a}, R⁵, R⁶, and R⁷ have the definition indicated above, and
(ii) optionally acylating or alkylating the hydroxy functionality formed in step (i) and, optionally, the secondary amine function of the specific mono- and/or bisalkylenetrialkoxysilanes of the general formula (I-a), using an acylating agent selected from the group consisting of carbonyl chlorides of the formula R⁸Cl, carboxylic anhydrides of the formula (R⁸)₂O, in which R⁸ is C₁-C₂₀-alkanoyl, C₃-C₂₀-alkenoyl, or C₇-C₂₀-aryloyl, cyclic carboxylic anhydrides of the formula (IV-b1), and cyclic carboxylic anhydrides of the formula (IV-b2),

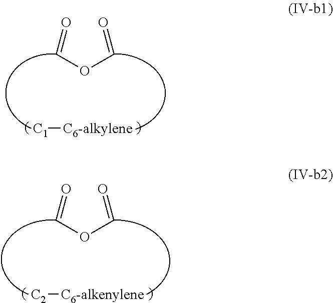

or using an alkylating agent selected from the group consisting of R⁸X, in which R⁸ is C₁-C₂₀-alkyl, C₂-C₂₀-alkenyl, or C₂-C₂₀-alkynyl and X is Cl, Br, I, OS(═O)₂CF₃ (trifluoromethanesulfonate), OS(═O)₂CH₃ (methanesulfonate), or toluenesulfonate.

In the context of the present invention, the expression “C₁-C₆-alkylene” encompasses the acyclic hydrocarbon units methylene, ethylene, n-propylene, 1-methylethylene, n-butylene, 1-methylpropylene, 2-methylpropylene, 1,1-dimethylethylene, n-pentylene, 1-methylbutylene, 2-methylbutylene, 3-methylbutylene, 1,1-dimethylpropylene, 2,2-dimethylpropylene, 1,2-dimethylpropylene, 1-ethylpropylene, n-hexylene, 1-methylpentylene, 2-methylpentylene, 3-methylpentylene, 4-methylpentylene, 1,1,-dimethylbutylene, 1,2-dimethylbutylene, 1,3-dimethylbutylene, 2,2-dimethylbutylene, 2,3-dimethylbutylene, 3,3-dimethylbutylene, 1-ethylbutylene, 2-ethylbutylene, 1-ethyl-1-methylpropylene, 1-ethyl-2-methylpropylene, 2-ethyl-1-methylpropylene, and 2-ethyl-2-methylpropylene.

Correspondingly, the expression “C₂-C₆-alkenylene” encompasses the acyclic hydrocarbon units having 2 to 6 carbon atoms: ethenylene, prop-1-enyl, prop-2-enyl, 2-methylprop-2-enylene, 1-methylprop-2-enylene, but-3-enylene, but-2-enylene, pent-1-enylene, pent-2-enylene, pent-3-enylene, 1-methylbut-1-enylene, 2-methylbut-1-enylene, 3-methylbut-1-enylene, 1-methylbut-2-enylene, 2-methylbut-2-enylene, 3-methylbut-2-enylene, 1-methylbut-3-enylene, 2-methylbut-3-enylene, 3-methylbut-3-enylene, 1-ethylprop-1-enylene, 1-ethylprop-2-enylene, hex-1-enylene, hex-2-enylene, hex-3-enylene, hex-4-enylene, hex-5-enylene, 1-methylpent-1-enylene, 2-methylpent-1-enylene, 3-methylpent-1-enylene, 4-methylpent-1-enylene, 1-methylpent-2-enylene, 2-methylpent-2-enylene, 3-methylpent-2-enylene, 4-methylpent-2-enylene, 1-methyl pent-3-enylene, 2-methylpent-3-enylene, 3-methylpent-3-enylene, 4-methylpent-3-enylene, 1-methylpent-4-enylene, 2-methylpent-4-enylene, 3-methylpent-4-enylene, 4-methylpent-4-enylene, 1,2-dimethylbut-1-enylene, 1,3-dimethylbut-1-enylene, 3,3-dimethylbut-1-enylene, 1,1-dimethylbut-2-enylene, 1,2-dimethylbut-2-enylene, 1,3-dimethylbut-2-enylene, 2,3-dimethylbut-2-enylene, 1,1-dimethylbut-3-enylene, 1,2-dimethylbut-3-enylene, 1,3-dimethylbut-3-enylene, 2,2-dimethylbut-3-enylene, and 2,3-dimethylbut-3-enylene.

The present invention is described in more detail, but not limited, by the following examples.

### EXAMPLES

### Example 1: Synthesis of Inventive (polyoxyethylene)amino-bis-alkylenetrimethoxysilane of the Formula (I-a1)

### Pluriol®A 1020 E-Amine:

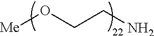

50.0 g (50 mmol, M=1000 g/mol) of Pluriol®A 1020 E-Amine (polyoxyethylenamine mixture having an average number of oxyethylene units of 22) are placed in a predried 100 mL three-neck flask and heated to 70° C. in a nitrogen atmosphere. Then 24.82 g (105 mmol, M=236.34 g/mol) of glycidyloxypropyltrimethoxysilane are added with stirring and the reaction mixture is stirred further at 100° C. At time intervals of 2 hours, the progress of the reaction is ascertained by thin-layer chromatography (CHCl₃/MeOH/water 88:11:1; Rf (Pluriol®A 1020 E-Amine)=0.1, Rf (glycidyloxypropyltrimethoxysilane)=0.74, Rf (intermediate with a silane head group)=0.3, Rf (product)=0.5). After 4 hours, all of the Pluriol®A 1020 E-Amine has reacted, and the reaction is ended.

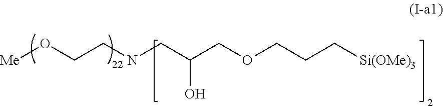

pH (5% in water): 7

¹H NMR (500 MHz, CDCl₃): δ=0.6-0.7 ppm, m, 4H, CH₂—CH₂—Si; 1.65-1.75 ppm, m, 4H, CH₂—CH₂—Si; 2.2 ppm, broad s, 2H, OH; 2.5-2.9 ppm, m, 6H, CH₂—N; 3.35, s, 3H, O—CH₃; 3.4-3.8 ppm, m, 94H, O—CH₂—CH₂—O/CHOH; 3.5-3.6 ppm, m, 18H, Si—O—CH₃.

### Example 2: Synthesis of Inventive (polyoxyethylene)amino-bis-alkylenetriethoxysilane of the Formula (I-a2)

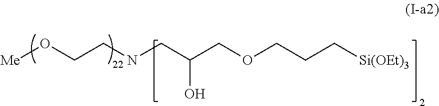

40.0 g (40 mmol, M=1000 g/mol) of Pluriol®A 1020 E-Amine are placed in a predried 100 mL three-neck flask and heated to 70° C. in a nitrogen atmosphere. Then 23.4 g (82 mmol, M=278.4 g/mol) of glycidyloxypropyltrimethoxysilane are added with stirring and the reaction mixture is stirred further at 100° C. At time intervals of 2 hours, the progress of the reaction is ascertained by thin-layer chromatography (CHCl₃/MeOH/water 88:11:1; Rf (Pluriol®A 1020 E-Amine)=0.1, Rf (glycidyloxypropyltrimethoxysilane)=0.74, Rf (intermediate with a silane head group)=0.3, Rf (product)=0.5). After 8 hours, all of the Pluriol®A 1020 E-Amine has reacted.

¹H NMR (500 MHz, CDCl₃): δ=0.6-0.7 ppm, m, 4H, CH₂—CH₂—Si; 1.2 ppm, t, 18H, Si—O—CH₂—CH₃; 1.65-1.75 ppm, m, 4H, CH₂—CH₂—Si; 2.5-2.9 ppm, m, 6H, CH₂—N; 3.35, s, 3H, O—CH₃; 3.4-3.6 ppm, m, 10H, CH₂—O; 3.6-3.7 ppm, m, 82H, O—CH₂—CH₂—O; 3.8 ppm, m, 14H, Si—O—CH₂—CH₃/CH—OH.

### Example 3: Synthesis of Inventive (polyoxyethylene)amino-bis-alkylenetrimethoxysilane of the Formula (I-a3)

### Pluriol®A 2010 E-Amine:

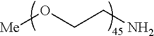

100.0 g (50 mmol, M=2000 g/mol) of Pluriol®A 2010 E-Amine (polyoxyethylenamine mixture having an average number of oxyethylene units of 45) are placed in a predried 250 mL four-neck flask and heated to 70° C. in a nitrogen atmosphere. Then 24.8 g (103 mmol, M=236.3 g/mol) of glycidyloxypropyltrimethoxysilane are added with stirring and the reaction mixture is stirred at 120° C. for 8 hours and at 140° C. for a further 7 hours. At time intervals of 3 hours, the progress of the reaction is ascertained by thin-layer chromatography. After 15 hours, Pluriol®A 1020 E-Amine has completely reacted.

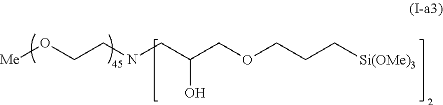

¹H NMR (500 MHz, CDCl₃): δ=0.6-0.7 ppm, m, 4H, CH₂—CH₂—Si; 1.65-1.75 ppm, m, 4H, CH₂—CH₂—Si; 2.2 ppm, broad s, 2H, OH; 2.5-2.9 ppm, m, 6H, CH₂—N; 3.35, s, 3H, O—CH₃; 3.4-3.8 ppm, m, 188H, O—CH₂—CH₂—O and CHOH; 3.5-3.6 ppm, m, 18H, Si—O—CH₃.

### Example 4: Synthesis of Inventive (polyoxyethylene)amino-bis-alkylenetrimethoxysilane of the Formula (I-a4)

100.0 g (50 mmol, M=2000 g/mol) of Pluriol®A 2010 E-Amine are placed in a predried 250 mL four-neck flask and heated to 80° C. in a nitrogen atmosphere. Then first 0.05 g (2.5 mmol; M=18 g/mol) of deionized water and subsequently 24.8 g (103 mmol, M=236.3 g/mol) of glycidyloxypropyltrimethoxysilane are added with stirring. The reaction mixture is heated to 100° C. and stirred at this temperature for 1 hour. The temperature is then raised to 140° C., stirring is carried out at this temperature for 9 hours, and a further 0.05 g of deionized water is added. After a further 2 hours, the reaction is ended.

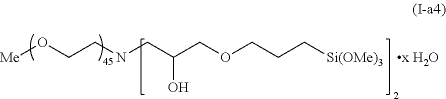

¹H NMR (500 MHz, CDCl₃): δ=0.6-0.7 ppm, m, 4H, CH₂—CH₂—Si; 1.65-1.75 ppm, m, 4H, CH₂—CH₂—Si; 2.2 ppm, broad s, 2H, OH; 2.5-2.9 ppm, m, 6H, CH₂—N; 3.35, s, 3H, O—CH₃; 3.4-3.9 ppm, m, 188H, O—CH₂—CH₂—O and CHOH; 3.5-3.6 ppm, m, 18H, Si—O—CH₃.

### Example 5: Synthesis of Inventive (polyoxyethylene)amino-bis-alkylenetrimethoxysilane of Formula (I-a5)

50.0 g (50 mmol, M=1000 g/mol) of Pluriol®A 1020 E-Amine are placed in a predried 100 mL three-neck flask and heated to 80° C. in a nitrogen atmosphere. Then 12.4 g (52 mmol, M=236.3 g/mol) of glycidyloxypropyltrimethoxysilane are added with stirring. The reaction mixture is heated to 140° C. and stirred at this temperature for 12 hours. Every 4 hours, the progress of the reaction is monitored by thin-layer chromatography (CHCl₃/MeOH/water 88:11:1). A skin is formed on the mixture. After 12 hours, the reaction is ended.

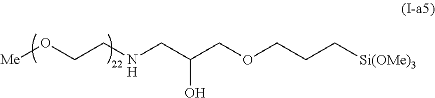

¹H NMR (500 MHz, CDCl₃): δ=0.6-0.8 ppm, m, 2H, CH₂—CH₂—Si; 1.60-1.80 ppm, m, 2H, CH₂—CH₂—Si; 2.5-2.9 ppm, m, 4H, CH₂—N; 3.35, s, 3H, O—CH₃; 3.4-3.9 ppm, m, 95H, O—CH₂—CH₂—O and CHOH; 3.5-3.6 ppm, m, 18H, Si—O—CH₃.

### Example 6: Synthesis of Inventive (polyoxyethylene)amino-bis-alkylenetrimethoxysilane of the Formula (I-b1)

15.0 g (10.2 mmol, M=1472.7 g/mol) of the crude product obtained in example 1 of (polyoxyethylene)amino-bis-alkylenetrimethoxysilane of the formula (I-a1) are placed in a predried 100 mL three-neck flask and heated to 40° C. under reduced pressure. After 30 minutes, the formation of bubbles is no longer observed. Then 2.1 g (20.9 mmol, M=98 g/mol) of maleic anhydride are added and the resulting reaction mixture is heated to 70° C. in a nitrogen atmosphere and stirred at this temperature. The progress of the reaction is monitored by thin-layer chromatography (CHCl₃/MeOH/water 88:11:1). After 2 hours, all of the starting material has reacted, and the reaction is ended.

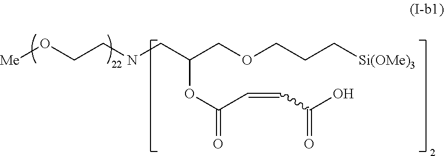

¹H NMR (500 MHz, CDCl₃): δ=0.6-0.7 ppm, m, 4H, CH₂—CH₂—Si; 1.65-1.75 ppm, m, 4H, CH₂—CH₂—Si; 2.2 ppm, broad s, 1H, OH; 2.5-2.9 ppm, m, 6H, CH₂—N; 3.35, s, 3H, O—CH₃; 3.4-3.8 ppm, m, 94H, O—CH₂—CH₂—O; 3.5-3.6 ppm, m, 18H, Si—O—CH₃; 4.2-4.4 ppm, m, 2H, CHOC(═O); 6.2 ppm, d, 2H, CH—C(O)OH; 6.4 ppm, d, 2H, CH—C(═O)O—C.

### Example 7: Synthesis of Inventive (polyoxyethylene)amino-bis-alkylenetriethoxysilane of the Formula (I-b2)

25.0 g (16.1 mmol, M=1556.8 g/mol) of the (polyoxyethylene)amino-bis-alkylenetriethoxysilane of the formula (I-a2) obtained from example 2 are placed in a predried 100 mL three-neck flask and heated to 70° C. under reduced pressure. When the alkylenetriethoxysilane of the formula (I-a2) has liquefied, 3.37 g (33.0 mmol, M=100 g/mol) of succinic anhydride are added and the resulting reaction mixture is stirred at 70° C. in a nitrogen atmosphere. The progress of the reaction is monitored by thin-layer chromatography (CHCl₃/MeOH/water 88:11:1). After 2 hours, all of the starting material has reacted, and the reaction is ended.

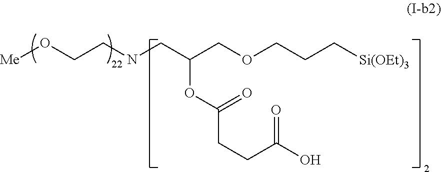

pH (5% in water): 4-5

¹H NMR (500 MHz, CDCl₃): δ=0.6-0.7 ppm, m, 4H, CH₂—CH₂—Si; 1.2 ppm, t, 18H, Si—O—CH₂—CH₃; 1.65-1.75 ppm, m, 4H, CH₂—CH₂—Si; 2.55-2.65 ppm, m, 8H, CH₂—CO₂; 2.7-2.8 ppm, m, 6H, CH₂—N; 3.35 ppm, s, 3H, O—CH₃; 3.4-3.7 ppm, m, 94H, CH₂—O; 3.8 ppm, q, 12H, Si—O—CH₂—CH₃; 5.1 ppm, m, 2H CHOC(═O); 8-9 ppm, broad s, 2H, COOH.

### Example 8: Synthesis of Inventive (polyoxyethylene)amino-bis-alkylenetriethoxysilane of the Formula (I-b6)

21.1 g (13.7 mmol, M=1556.8 g/mol) of the (polyoxyethylene)amino-bis-alkylenetriethoxysilane of the formula (I-a2) obtained from example 2 are placed in a predried 100 mL three-neck flask and heated to 70° C. When the alkylenetriethoxysilane of the formula (I-a2) has liquefied, 2.8 g (28.0 mmol, M=98 g/mol) of maleic anhydride are added and the resulting reaction mixture is stirred at 70° C. in a nitrogen atmosphere. The progress of the reaction is monitored by thin-layer chromatography (CHCl₃/MeOH/water 88:11:1). After 4 hours, all of the starting material has reacted, and the reaction is ended.

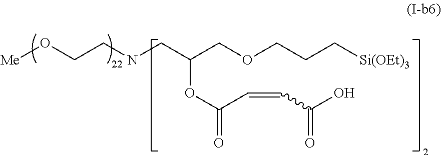

¹H NMR (500 MHz, CDCl₃): δ=0.6-0.7 ppm, m, 4H, CH₂—CH₂—Si; 1.2 ppm, t, 18H, Si—O—CH₂—CH₃; 1.65-1.75 ppm, m, 4H, CH₂—CH₂—Si; 2.3-2.8 ppm, m, 6H, CH₂—N; 3.35, s, 3H, O—CH₃; 3.4-3.7 ppm, m, 90H, CH₂—O; 3.8 ppm, q, 12H, Si—O—CH₂—CH₃; 4.2-4.3, m, 2H, HCOC(═O); 6.2 d, CH—C(O)OH, 6.4, d, CH—C(═O)O—C; 10-11 ppm, broad s, 2H, COOH.

### Example 9: Synthesis of Inventive (polyoxyethylene)amino-bis-alkylenetrimethoxysilane of the Formula (I-b3)

50.0 g (20.2 mmol, M=2472.6 g/mol) of the (polyoxyethylene)amino-bis-alkylenetrimethoxysilane of the formula (I-a3) obtained from example 3 are placed in a predried 250 mL four-neck flask and heated to 80° C. When the alkylenetrimethoxysilane of the formula (I-a3) has liquefied, 4.25 g (41.4 mmol, M=100 g/mol) of succinic anhydride are added and the resulting reaction mixture is stirred at 80° C. in a nitrogen atmosphere. The progress of the reaction is monitored by thin-layer chromatography (CHCl₃/MeOH/water 88:11:1). After 6 hours, all of the starting material has reacted, and the reaction is ended.

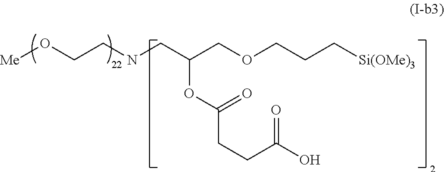

¹H NMR (500 MHz, CDCl₃): δ=0.6-0.7 ppm, m, 4H CH₂—CH₂—Si; 1.65-1.75 ppm, m, 4H, CH₂—CH₂—Si; 2.5-2.9 ppm, m, 14H, CH₂—CO₂ and CH₂—N; 3.35, s, 3H, O—CH₃; 3.4-3.8 ppm, m, 206H, O—CH₂—CH₂—O, Si—OCH₃; 5.1 ppm, m, 2H CHOC(O); 11-12 ppm, broad s, 2H, COOH.

### Example 10: Synthesis of Inventive (polyoxyethylene)amino-bis-alkylenetrimethoxysilane of the Formula (I-b3)

50.0 g (20.2 mmol, M=2472.6 g/mol) of the (polyoxyethylene)amino-bis-alkylenetrimethoxysilane of the formula (I-a4) obtained from example 4 are placed in a predried 250 mL four-neck flask and heated to 80° C. When the alkylenetrimethoxysilane of the formula (I-a4) has liquefied, 4.25 g (41.4 mmol, M=100 g/mol) of succinic anhydride are added and the resulting reaction mixture is stirred at 80° C. in a nitrogen atmosphere. The progress of the reaction is monitored by thin-layer chromatography (CHCl₃/MeOH/water 88:11:1). After 6 hours, all of the starting material has reacted, and the reaction is ended.

¹H NMR (500 MHz, CDCl₃): δ=0.6-0.7 ppm, m, 4H CH₂—CH₂—Si; 1.65-1.75 ppm, m, 4H, CH₂—CH₂—Si; 2.5-2.9 ppm, m, 10H, CH₂—CO₂ and CH₂—N; 3.35, s, 3H, O—CH₃; 3.4-3.8 ppm, m, 210H, O—CH₂—CH₂—O, Si—OCH₃ and CH₂—N; 5.1 ppm, m, 2H CHOC(O); 11-12 ppm, broad s, 2H, COOH.

### Example 11: Synthesis of Inventive (polyoxyethylene)amino-bis-alkylenetrimethoxysilane of the Formula (I-b5)

29.03 g (23.5 mmol, M=1236.3 g/mol) of the (polyoxyethylene)amino-alkylenetrimethoxysilane of the formula (I-a5) obtained from example 5 are placed in a predried 50 mL single-neck flask and heated to 100° C. When the alkylenetrimethoxysilane of the formula (I-a5) has liquefied, 4.7 g (47 mmol, M=100 g/mol) of succinic anhydride are added and the resulting reaction mixture is stirred at 140° C. for 4 hours in a nitrogen atmosphere. The progress of the reaction is monitored by thin-layer chromatography (CHCl₃/MeOH/water 88:11:1). After 4 hours, all of the starting material has reacted, and the reaction is ended.

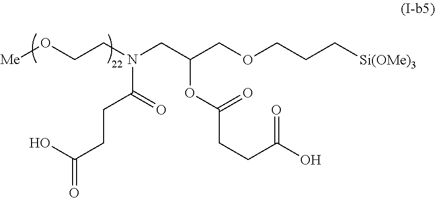

¹H NMR (500 MHz, CDCl₃): δ=0.6-0.7 ppm, m, 4H CH₂—CH₂—Si; 1.65-1.75 ppm, m, 4H, CH₂—CH₂—Si; 2.5-2.9 ppm, m, 8H, CH₂—CO₂; 3.35, s, 3H, O—CH₃; 3.4-3.8 ppm, m, 100H, O—CH₂—CH₂—O, Si—OCH₃ and CH₂—N; 5.1 ppm, m, 1H CHOC(O); 11-12 ppm, broad s, 2H, COOH.

### Comparative Example 1: Synthesis of the Polycarboxylate Ether (PCE) (V)

Sokalan®PA 25 XS: Polyacrylic acid (M=5000 g/mol)

### Pluriol®A 1020 E:

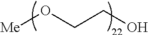

A flask is charged with Sokalan®PA 25 XS (3.0 equivalents, M=5000 g/mol), Pluriol®A 1020 E (1.0 equivalent, M=1000 g/mol), and catalytic amounts of methylsulfonic acid. Then, at a temperature of 175° C. and under a pressure of 20 mbar, the water of condensation liberated during the esterification is removed until thin-layer chromatography indicates full reaction of Pluriol®A 1020 E.

### Comparative example 2: Synthesis of (polyoxyalkylene)trioxypropyleneamino-bis-methylene-phosphonic acid (VI)

The (polyoxyalkylene)trioxypropyleneamino-bis-methylenephosphonic acid (VI) is prepared in accordance with FR 2696736, example 1 b) starting from Jeffamine®M 1000.

### Use Examples 12 to 28: Determination of Fresh Mortar Consistency

First of all a standardized mortar according to DIN EN196-1 is prepared from
450 g of cement (“Heidelberger Zement” CEM I, 42.5 R),
1350 g of sand, and
225 g of deionized water (taking account of the water added subsequently with the plasticizer).

The mortar components are mixed for 90 seconds, then admixed with an aqueous mixture comprising a plasticizer (0.10 to 0.20 wt %, based on the dry weight of the cement) and Degressal® SD 40 as defoamer (7 wt %, based on the dry weight of the corresponding plasticizer), followed by mixing for a further 60 seconds. The mortar thus produced is introduced in two layers into a truncated cone mold, with each layer of mortar being spread by 10 gentle taps with a pestle in such a way that the truncated cone mold is filled uniformly. Thereafter the projecting mortar is stripped off flush. After 10 to 15 seconds, the slump cone is drawn off slowly upward vertically, and the mortar is caused to slump by 15 reciprocal taps (one reciprocal tap per second). The diameter of the mortar cake is measured at two locations positioned at right angles to one another. The average from these two measurements is reported as the slump flow in table 1.

Following the measurement, the mortar is removed from the slump board. The test is repeated with the same mortar after 30, 60, 90, 120, and 150 minutes. Slump flows for mortars with different composition, determined in this way, are shown in table 1.

TABLE 1

| | | wt % | | | | | | |
|---|---|---|---|---|---|---|---|---|
| | | based | Mortar slump flow [cm] | | | | | |
| Ex. | Admixture^{[1]} | on cement | 1 min | 30 min | 60 min | 90 min | 120 min | 150 min |
| 12 | none | — | 17.7 | 15.7 | 15.0 | 13.4 | | |
| | (comparative) | | | | | | | |
| 13 | Bis-silane I-a1 | 0.10 | 21.5 | 18.6 | 17.8 | 16.6 | | |
| 14 | Bis-silane I-a1 | 0.20 | 26.7 | 20.9 | 19.4 | 18.0 | 17.0 | |
| 15 | Bis-silane I-b1 | 0.10 | 22.8 | 19.7 | 18.1 | 16.8 | | |
| 16 | Bis-silane I-b1 | 0.20 | 25.5 | 22.4 | 20.0 | 19.1 | 17.8 | |
| 17 | Bis-silane I-a2 | 0.10 | 21.1 | 19.8 | 18.9 | 18.7 | | 17.3 |
| 18 | Bis-silane I-a2 | 0.20 | 22.3 | 21.2 | 21.0 | 20.2 | 20.2 | 19.4 |
| 19 | Bis-silane I-b2 | 0.20 | 25.5 | 21.6 | 19.7 | 18.1 | 17.7 | 16.5 |
| 20 | Bis-silane I-b6 | 0.20 | 26.3 | 21.7 | 19.7 | 18.1 | 17.0 | 16.0 |
| 21 | PCE V | 0.10 | 26.1 | 20.3 | 18.5 | 16.0 | | |
| 22 | PCE V + | 0.08 | 25.1 | 19.1 | 16.3 | 15.3 | | |
| | Bis-silane I-b2 | 0.02 | | | | | | |
| 23 | PCE V + | 0.10 | 26.8 | 19.4 | 16.6 | 15.7 | | |
| | Bis-silane I-b2 | 0.02 | | | | | | |
| 24 | Bis-silane I-b3 | 0.20 | 26.6 | 22.3 | 20.6 | 19.3 | 18.4 | 17.5 |
| 25 | Bis-silane I-a4 | 0.20 | 26.1 | 21.1 | 19.2 | 18.2 | 18.2 | 17.3 |
| 26 | Bis-phosphonic | 0.20 | 22.5 | 19.0 | 17.7 | 16.5 | | |
| | acid VI | | | | | | | |
| 27 | Monosilane | 0.20 | 24.6 | 20.8 | 19.6 | 18.3 | 18.1 | 17.4 |
| | I-a5 | | | | | | | |
| 28 | Monosilane | 0.20 | 26.8 | 20.9 | 19.0 | 18.1 | 17.5 | 16.9 |
| | I-b5 | | | | | | | |

^{[1]}Admixture additionally contains 7 wt % of Degressal ®SD 40 defoamer, based on the dry weight of the respective plasticizer.
^{[2]}Water/cement value (w/c) = 0.50; ratio of sand to cement = 3.0.

From the figures in table 1 it is clear that through the addition of the inventive (polyoxyethylene)amino-bis-alkylenetrialkoxysilanes, silanes (I-la), (I-a2), (I-a4), (I-b1), (I-b2), (I-b3), (I-b6), (I-a5), (I-b5) (Ex. 13-20, 24, 25, 27, and 28), success is achieved in plasticizing the mortar to higher slump flow levels.

Example 12 in table 1 shows, for comparison, the slump flow of the same mortar without addition of plasticizer. As can be seen, the slump flow is initially around 17.7 cm, and then falls back within just 90 minutes to 13.4 cm. The addition of just 0.10 wt %, based on the dry weight of the cement, of one of the inventive bis-silanes (I-a1), (I-a2), or (I-b1) (Ex. 13, 15, 17) results in an increase in the slump flow by around 3 to 5 cm. This can be increased further by raising the amount of plasticizer (see Ex. 14, 16, 18-20, 24, 25, 27, and 28).

In comparison to the bis-phosphonic acid VI (example 26), the inventive plasticizers produce a greater increase in the slump flow for the same amount (see examples 14, 16, 18-20, 24, 25, 27, and 28).

In short testing times, the polycarboxylate ether (PCE) V of the comparative example (example 21) is approximately comparable with the inventive plasticizers in relation to the effect of plasticizing the mortar to defined slump flow levels. However, the effect subsides more quickly, and can no longer be determined over 90 minutes.

### Use Examples 29 to 45: Determination of Dynamic Viscosity

For use as intended, a significant part is played not only by the plasticizing effect but also by the lowering of the fresh mortar viscosity. The viscosity is a measure of the flowability and also, in the present context, a measure of the pumpability and workability of the fresh mortar. Lower viscosity levels in this context result in better workability, and more particularly in better pumpability of the fresh mortar. Moreover, the capacity for the fresh mortar to be placed in molds is made easier.

The viscosity is measured on an Anton Paar MCR 102 rheometer. The mortar used for these measurements is prepared according to DIN EN196-1, as described above. The measuring system used is a specific cell for building materials (BMC-90). The stirrer used is the ST59-2V-44.3/120. 10 measurements are carried out, in each case at a shear rate of 10 s⁻¹. The measurement time per measurement amounts to 5 seconds. Between the measurements, the system is allowed to stand for 595 seconds without being stirred. The values determined for the dynamic viscosity in this test are shown in table 2

TABLE 2

| | Admixture^{[1]} (wt %, | Dynamic viscosity of mortar [mPa · s] | | | | | |
|---|---|---|---|---|---|---|---|
| Ex. | based on cement^{[2]}) | 1 min | 10 min | 20 min | 30 min | 40 min | 50 min |
| 29 | Bis-phosphonic acid VI | 86 | 122 | 140 | 153 | 161 | 146 |
| | (0.20) | | | | | | |
| 30 | PCE V (0.10) | 1583 | 3050 | 12 036 | 621 605 | 1 023 167 | 1 922 460 |
| 31 | PCE V (0.08) + | 94 | 2650 | 259 796 | 682 254 | 912 002 | 1 560 932 |
| | bis-silane I-b2 (0.02) | | | | | | |
| 32 | PCE V (0.10) + | 83 | 87 | 120 | 142 | 196 | 230 |
| | bis-silane I-b2 (0.02) | | | | | | |
| 33 | bis-silane I-a1 (0.10) | 433 | 15 022 | 437 448 | 821 556 | 1 012 217 | 1 811 457 |
| 34 | bis-silane I-a1 (0.20) | 72 | 81 | 92 | 118 | 115 | 138 |
| 35 | bis-silane I-b1 (0.10) | 267 | 14 697 | 357 544 | 591 309 | 1 151 576 | 1 479 875 |
| 36 | bis-silane I-b1 (0.20) | 40 | 50 | 58 | 65 | 72 | 79 |
| 37 | bis-silane I-a2 (0.20) | 471 | 1027 | 81 738 | 394 504 | 403 734 | 806 765 |
| 38 | bis-silane I-b2 (0.20) | 130 | 152 | 138 | 172 | 165 | 178 |
| 39 | bis-silane I-b5 (0.20) | 92 | 94 | 117 | 136 | 143 | 151 |
| 40 | bis-silane I-b3 (0.20) | — | — | — | 50 | 51 | 56 |
| 41 | bis-silane I-a4 (0.20) | — | — | — | 244 | 97 | 96 |
| 42 | bis-silane I-a3 (0.20) | — | — | — | 102 | 69 | 75 |
| 43 | bis-silane I-b4 (0.20) | — | — | — | 38 | 36 | 36 |
| 44 | mono-silane I-a5 (0.20) | — | — | — | 194 | 88 | 104 |
| 45 | mono-silane I-b5 (0.20) | — | — | — | 73 | 65 | 76 |

| | Dynamic viscosity of mortar [mPa · s] | | | | | | | | |
|---|---|---|---|---|---|---|---|---|---|
| Ex. | 60 min | 80 min | 90 min | 100 min | 110 min | 120 min | 130 min | 140 min | 150 min |
| 29 | 146 | | | | | | | | |
| 30 | 3 104 904 | | | | | | | | |
| 31 | 2 326 906 | | | | | | | | |
| 32 | 74 719 | 747 140 | 1 238 010 | | | | | | |
| 33 | 3 204 085 | | | | | | | | |
| 34 | 137 | | | | | | | | |
| 35 | 2 628 725 | | | | | | | | |
| 36 | 87 | | | | | | | | |
| 37 | 1 196 279 | | | | | | | | |
| 38 | 184 | | | | | | | | |
| 39 | 161 | | | | | | | | |
| 40 | 59 | 71 | 78 | 76 | 82 | 83 | 86 | 85 | 80 |
| 41 | 96 | 115 | 124 | 114 | 115 | 121 | 119 | 122 | 117 |
| 42 | 82 | 96 | 104 | 127 | 121 | 130 | 125 | 132 | 143 |
| 43 | 35 | 38 | 42 | 44 | 46 | 50 | 52 | 54 | 59 |
| 44 | 121 | 136 | 178 | 111 | 119 | 145 | 157 | 352 | 26 785 |
| 45 | 101 | 195 | 131 | 154 | 137 | 189 | 158 | 291 | 32 821 |

^{[1]}Admixture additionally contains 7 wt % of Degressal ®SD 40 defoamer, based on the dry weight of the respective plasticizer.
^{[2]}Water/cement value (w/c) = 0.50; ratio of sand to cement = 3.0.

As can be seen from table 2, there is a sharp increase in the dynamic viscosity in a comparatively short time when PEC (V) (example 30) is used in the mortar. This leads to a reduced flowability and ultimately, in particular, to a marked curtailment of the time during which the mortar is workable.

Above a certain amount, the inventive bis-silanes (I-a1), (I-a3), (I-a4), and (I-b1) to (I-b4) (examples 34, 36, and 38 to 43) bring about a much slower increase in the dynamic viscosity by comparison with PEC (V) (example 30). The viscosity values in this case are mostly below the values reached through the use of the plasticizer bis-phosphonic acid (VI) (example 29).

Example 31 in table 2 shows that at low levels of addition of the bis-silane, no saving of PCE can be made. However, by a small addition of bis-silane to a PCE added at normal levels, it is possible to achieve a large increase in the viscosity-reducing effect (example 32). This effect, however, is of limited duration. These results suggest that a further prolongation of the desired effect may be achieved by adding the bis-silane at a higher level.

### Use Examples 46 to 55: Determination of Flexural Tensile Strength and Compressive Strength

The mortar for the prism-shaped sample specimens is produced according to DIN EN 196-1, as described above. A difference, however, is that the admixtures are added to the cement directly with the water, before the sand is admixed. For each value to be determined, three mortar prisms are produced, in order to compensate for any measurement uncertainties.

The prism molds with dimensions of 40×40×160 mm are stretched out on a shaker table. The mortar is then introduced in uniform distribution into the prism molds, and compacted by vibration over a period of 120 seconds (vibration amplitude: 0.7 mm). The molds are then stretched out, and excess mortar is stripped off flush. The molds are covered and stored for 24 hours in accordance with the standard, at 20° C. and an atmospheric humidity of 90%, before demolding. The mortar specimens produced are subsequently demolded and stored further at 20° C. and 90% humidity until immediately prior to the beginning of measurement.

First of all, three each of the resulting mortar prisms are used to determine the flexural tensile strength. This is followed by measurement of the compressive strength on the six prism halves resulting from the flexural tensile strength determination.

The flexural tensile strength is determined using a Mega 10-200-10DM1 machine from Form+Test Prüfsysteme.

Table 3 shows the flexural tensile strength values (average values from three measurements in each case) determined using the mortar prisms.

TABLE 3

| | | | Flexural tensile | | | |
|---|---|---|---|---|---|---|
| | | % by weight based | strength [N/mm²] | | | |
| Ex. | Admixture^{[1]} | on cement^{[2]} | 24 h | 168 h | 336 h | 720 h |
| 46 | none | — | 4.39 | 5.76 | 6.64 | 7.02 |
| | (comparative) | | | | | |
| 47 | bis-silane I-a1 | 0.23 | 0.00 | 6.92 | 7.26 | 7.87 |
| 48 | bis-silane I-b1 | 0.23 | 0.00 | 7.33 | 8.02 | 8.07 |
| 49 | bis-silane I-a2 | 0.23 | 0.00 | 6.82 | 7.23 | 8.10 |
| 50 | bis-silane I-b2 | 0.23 | 0.00 | 7.05 | — | — |

^{[1]}Admixture additionally contains 7 wt % of Degressal ®SD 40 defoamer, based on the dry weight of the respective plasticizer.
^{[2]}Water/cement value (w/c) = 0.50; ratio of sand to cement = 3.0.

The compressive strength is determined using a Mega 10-200-10DM1 machine from Form+Test Prüfsysteme.

Table 4 shows the compressive strength values of the mortars produced (average values from six measurements in each case) determined using the prism halves.

TABLE 4

| | | | Compressive | | | |
|---|---|---|---|---|---|---|
| | | % by weight based | strength [N/mm²] | | | |
| Ex. | Admixture | on cement | 24 h | 168 h | 336 h | 720 h |
| 51 | none | — | 19.90 | 41.91 | 46.39 | 49.98 |
| | (comparative) | | | | | |
| 52 | bis-silane I-a1 | 0.23 | 0.00 | 44.62 | 43.83 | 48.61 |
| 53 | bis-silane I-b1 | 0.23 | 0.00 | 45.11 | 48.81 | 54.24 |
| 54 | bis-silane I-a2 | 0.23 | 0.00 | 43.01 | 48.39 | 54.45 |
| 55 | bis-silane I-b2 | 0.23 | 0.00 | 42.10 | — | — |

As can be seen from tables 3 and 4, both the flexural tensile strength and the compressive strength of the hardened mortar are influenced positively by use of the inventive bis-silanes (I-a2), (I-b1), and (I-b2) (table 3, examples 47 to 50; table 4, examples 52 to 55) after no later than 7 days (168 hours), as shown by the comparison with a mortar having the same composition but without addition of plasticizer (table 3, example 46; table 4, example 51).

### Use Examples 56 to 63: Measurement of Heats of Hydration

The mortar is produced in accordance with DIN EN 196-1, as described above in connection with use examples 46 to 55. Here as well, the admixtures are added right at the start of mortar production, with the water.

The freshly prepared mortar is placed in each case into a container. A temperature sensor (K-type temperature sensor, B & B Thermo-Technik GmbH) is then mounted in the container. A second container is filled with auxiliary-free mortar and fitted likewise with a temperature probe. The containers are then sealed and are isolated appropriately by application of insulating panels (Basotect®). The temperature is then measured over several hours (Digital 4-Channel Thermometer, Voltcraft; PC Plus software, Voltcraft; K-type temperature sensor, B & B Thermo-Technik GmbH) and a record is made in each case of the time at which the temperature maximum is reached. The difference between the two times (retardation time) is shown in table 5 below.

TABLE 5

| | | wt %, based on | |
|---|---|---|---|
| Ex. | Admixture^{[1]} | cement^{[2]} | Retardation time [min] |
| 56 | bis-silane I-a2 | 0.20 | 942 |
| 57 | bis-silane I-b2 | 0.20 | 795 |
| 58 | bis-silane I-b6 | 0.20 | 831 |
| 59 | bis-silane I-a1 | 0.20 | 1077 |
| 60 | bis-silane I-b1 | 0.20 | 639 |
| 61 | monosilane I-a5 | 0.20 | 453 |
| 62 | monosilane I-b5 | 0.20 | 342 |
| 63 | bis-phosphonic acid VI | 0.20 | 1020 |
| | (comparative) | | |

^{[1]}Admixture additionally contains 7 wt % of Degressal ®SD 40 defoamer, based on the dry weight of the respective plasticizer.
^{[2]}Water/cement value (w/c) = 0.50; ratio of sand to cement = 3.0.

As is clear from the retardation times listed in table 5, the inventive silanes (I-a2), (I-a5), (I-b1), (I-b2), (I-b5), and (I-b6) (examples 56 to 62) retard the development of early strength in the mortar less greatly than the prior-art plasticizer, bis-phosphonic acid (VI).

In summary, use examples 12 to 63 show that the inventive mono- and bis-silanes (I-a) and (I-b) are of similarly good suitability in the plasticizing of mortar, given a set water/cement ratio, the polycarboxylate ethers frequently employed for this purpose, such as PCE (V), for example. In contrast to the use of polycarboxylate ethers, however, the viscosity of the mortar when using the inventive mono- and bis-silanes (I-a) and (I-b) does not rise nearly as quickly, and this improves the workability of the mortar and, in particular, prolongs the time within which working (pumping, incorporating, spreading) of mortar is possible.

1: A mono- or bisalkylenetrialkoxysilane of the formula (I): 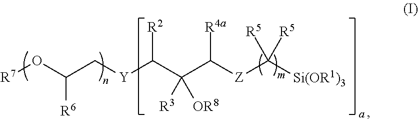
wherein:
—Y— is —O— or —N(R⁹)₂₋ₐ—;
—Z— is in each case identical or different and selected from the group consisting of —O— and —CHR^{4b}—;
a is 1 if —Y—=—O—, and is 1 or 2 if —Y—=—N(R⁹)₂₋ₐ—;
m is a natural number from 1 to 20;
n is a natural number from 7 to 200;
R¹ is in each case identical or different and selected from the group consisting of methyl, ethyl, n-propyl, isopropyl, n-butyl, isobutyl, sec-butyl, tert-butyl, and phenyl;
R², R³, R^{4a} and R^{4b} are in each case identical or different and selected from the group consisting of H and linear or branched C₁-C₁₀-alkyl, or
R² together with R^{4a} forms an alkylene chain —R²—R^{4a}—, the alkylene chain being selected from the group consisting of —C(R⁵)₂—C(R⁵)₂— and —C(R⁵)₂—C(R⁵)₂—C(R⁵)₂—, and R³ and R^{4b} are in each case identical or different and selected from the group consisting of H and linear or branched C₁-C₁₀-alkyl, or
R² together with R^{4b} forms an alkylene chain —R²—R^{4b}—, the alkylene chain being selected from the group consisting of —C(R⁵)₂— and —C(R⁵)₂—C(R⁵)₂—, and R³ and R^{4a} are in each case identical or different and selected from the group consisting of H and linear or branched C₁-C₁₀-alkyl;
R⁵ is in each case identical or different and selected from the group consisting of H and linear or branched C₁-C₆-alkyl;
R⁶ is in each case identical or different and selected from the group consisting of H, methyl, and ethyl;
R⁷ is selected from the group consisting of linear or branched C₁-C₂₀-alkyl, C₁-C₂₀-alkanoyl, and C₇-C₂₀-aryloyl; and
R⁸ and R⁹ are in each case identical or different and selected from the group consisting of H, linear or branched C₁-C₂₀-alkyl, C₂-C₂₀-alkenyl, C₂-C₂₀-alkynyl, C₁-C₂₀-alkanoyl, C₃-C₂₀-alkenoyl, and also co-carboxy-(C₁-C₆-alkyl)carbonyl and salts thereof, ω-carboxy-(C₂-C₆-alkenyl)carbonyl and salts thereof, and C₇-C₂₀-aryloyl.

2: The alkylenetrialkoxysilane according to claim 1, wherein:
—Z—=—O—; and
R², R³, and R^{4a} are in each case identical or different and selected from the group consisting of H and linear or branched C₁-C₁₀-alkyl.

3: The alkylenetrialkoxysilane according to claim 1, wherein:
m=3; and
R⁵=H.

4: The alkylenetrialkoxysilane according to claim 1, wherein:
—Z— is —CHR^{4b}; and
R² together with R^{4b} forms an alkylene chain —R²—R^{4b}—, the alkylene chain being selected from —C(R⁵)₂— and —C(R⁵)₂—C(R⁵)₂—; and
R³ and R^{4a} are in each case identical or different and selected from the group consisting of H and linear or branched C₁-C₁₀-alkyl.

5: The alkylenetrialkoxysilane according to claim 1, wherein the alkylenetrialkoxysilane has the formula (I-d11): 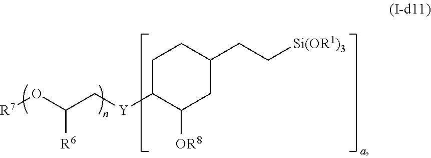
wherein Y, a, n, R¹, and R⁶ to R⁹ have the definition indicated in claim 1.

6: The alkylenetrialkoxysilane according to claim 1, wherein:
—Y—=—N(R⁹)₂₋ₐ—; and
a=1 or 2.

7: The alkylenetrialkoxysilane according to claim 1, wherein:
—Y—=—O—; and
a=1.

8: The alkylenetrialkoxysilane according to claim 1, wherein R⁸=H.

9: The alkylenetrialkoxysilane according to claim 1, wherein R⁸ is selected from the group consisting of a carboxy-(C₁-C₆-alkyl)carbonyl and a carboxy-(C₂-C₆-alkenyl)carbonyl.

10: The alkylenetrialkoxysilane according to claim 1, wherein n is a natural number from 21 to 120.

11: The alkylenetrialkoxysilane according to claim 1, wherein R⁶=H.

12: The alkylenetrialkoxysilane according to claim 1, wherein R⁷ is selected from the group consisting of methyl and acetyl.

13: A process for forming an aqueous suspension, the process comprising adding a dispersant to a mixture comprising an aggregate and a hydraulic binder, to obtain the aqueous suspension, wherein the dispersant is at least one alkylenetrialkoxysilane of claim 1.

14: The process according to claim 13, wherein the hydraulic binder is selected from the group consisting of a cement and a geopolymeric silicate binder.

15: An aqueous suspension, comprising:
an aggregate;
a hydraulic binder; and
a dispersant comprising the alkylenetrialkoxysilane according to claim 1.

16: A process for preparing the alkylenetrialkoxysilane according to claim 1, the process comprising:
(i) β-hydroxyalkylating a polyether alcohol or polyether amine of formula (II): 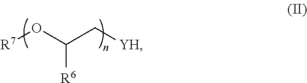
with one or more epoxy silanes of formula (III): 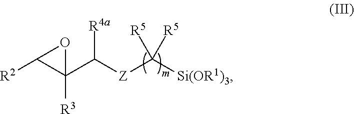
to form an alkylenetrialkoxysilane of formula (I-a), 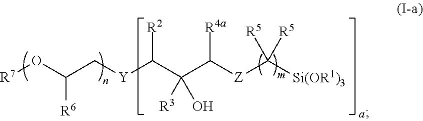
and
(ii) optionally acylating or alkylating the hydroxy functionality formed in step (i) and, optionally, the secondary amine function of the alkylenetrialkoxysilane of formula (I-a),
with an acylating agent selected from the group consisting of a carbonyl chloride of formula R⁸Cl, a carboxylic anhydride of formula (R⁸)₂O, in which R⁸ is C₁-C₂₀-alkanoyl, C₃-C₂₀-alkenoyl, or C₇-C₂₀-aryloyl, a cyclic carboxylic anhydride of formula (IV-b 1), and a cyclic carboxylic anhydride of formula (IV-b2): 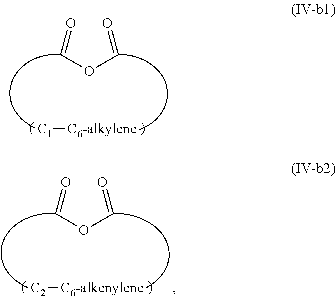
or
with an alkylating agent selected from the group consisting of R⁸X, in which R⁸ is C₁-C₂₀-alkyl, C₂-C₂₀-alkenyl, or C₂-C₂₀-alkynyl and X is Cl, Br, I, OS(═O)₂CF₃ (trifluoromethanesulfonate), OS(═O)₂CH₃ (methanesulfonate), or toluenesulfonate,
wherein:
—Y— is —O— or —N(R⁹)₂₋ₐ—;
—Z— is in each case identical or different and selected from the group consisting of —O— and —CHR^{4b}—;
a is 1 if —Y—=—O—, and is 1 or 2 if —Y—=—N(R⁹)₂₋ₐ—;
m is a natural number from 1 to 20;
n is a natural number from 7 to 200;
R¹ is in each case identical or different and selected from the group consisting of methyl, ethyl, n-propyl, isopropyl, n-butyl, isobutyl, sec-butyl, tert-butyl, and phenyl;
R², R³, R^{4a} and R^{4b} are in each case identical or different and selected from the group consisting of H and linear or branched C₁-C₁₀-alkyl, or
R² together with R^{4a} forms an alkylene chain —R²—R^{4a}, the alkylene chain being selected from the group consisting of —C(R⁵)₂—C(R⁵)₂— and —C(R⁵)₂—C(R⁵)₂—C(R⁵)₂—, and R³ and R^{4b} are in each case identical or different and selected from the group consisting of H and linear or branched C₁-C₁₀-alkyl, or
R² together with R^{4b} forms an alkylene chain —R²—R^{4b-}, the alkylene chain being selected from the group consisting of —C(R⁵)₂— and —C(R⁵)₂—C(R⁵)₂—, and R³ and R^{4a} are in each case identical or different and selected from the group consisting of H and linear or branched C₁-C₁₀-alkyl
R⁵ is in each case identical or different and selected from the group consisting of H and linear or branched C₁-C₆-alkyl;
R⁶ is in each case identical or different and selected from the group consisting of H, methyl, and ethyl; and
R⁷ is selected from the group consisting of linear or branched C₁-C₂₀-alkyl, C₁-C₂₀-alkanoyl, and C₇-C₂₀-aryloyl; and
R⁹ is selected from the group consisting of H, linear or branched C₁-C₂₀-alkyl, C₂-C₂₀-alkenyl, C₂-C₂₀-alkynyl, C₁-C₂₀-alkanoyl, C₃-C₂₀-alkenoyl, and also ω-carboxy-(C₁-C₆-alkyl)carbonyl and salts thereof, ω-carboxy-(C₂-C₆-alkenyl)carbonyl and salts thereof, and C₇-C₂₀-aryloyl.
